(19) United States
(12) Patent Application Publication
(10) Pub. No.: US 2009/0101773 A1
(43) Pub. Date: Apr. 23, 2009

(54) Camera pan head having two clamps locked connector

(76) Inventor: Yongjian Yang, Guangdong Province (CN)

Correspondence Address: MICHAEL N. LAU;LAU & ASSOCIATES, LLC, 2121 EISENHOWER AVENUE, SUITE 200, ALEXANDRIA, VA, 22314, US

(21) Appl. No.: 11/989,591

(22) PCT Filed: Nov. 24, 2005
(86) PCT No.: PCT/CN2005/001990

§ 371 Date: Jan. 29, 2008

(30) Foreign Application Priority Data
Aug. 9, 2005 (CN) 200510036399X

(51) Int. Cl. F16M 11/02

(52) U.S. Cl. 248/181.1

(57) ABSTRACT

A camera pan head having two clamps locked connector. There is provided with a linkage locking mechanism, which is composed of the left and right clamp, the pendulum lever, the hinge, and the twist spring, in the connector. On one side of the camera pan head is provided with a extension handle. Under the sphere seat of the bottom of the camera pan head is provided with a turntable, and there is provided with a circular scale around outer circumference of the turntable.

### TECHNICAL FIELDS OF THE INVENTION

This invention involves a kind of camera pan head having a connector, particularly a kind of camera pan head having a connector with two-clamps locking, a quadrate knot orientation connection and a turntable. It belongs to the technical fiels of the photographic equipment.

### PRIOR ART

In the installation between the camera and the tripod, the connecting plate, connecting turntable, and the turn platform are needed. These types of devices mostly have big size, not agile after connected with camera, and not easy for carrying. Besides, there is not orientation fixing, the camera is easy to loose and not secure. In general, camera ball head includes 3-dimension ball head and inverse sphere design ball head. The former needs adjustment in 3 different directions, which has slow operation, and be inconvenient when taking photos for the quick disappeared scene. Whereas, the sphere of the inverse sphere ball head faces downward, with the pan head fixing onto the camera support and the camera fixing on the sphere. This kind of construction will have the shortcoming of installation complicated, less clamping force, and low stability. Under large angle adjustment this kind of design needs to have 2 directions adjustment, and is inconvenient for the end-user. When the camera installed onto the tripod, it will be very complicated when taking photo under multi angle. It needs to change the handle position frequently to accomplish the aim. This patent applicant, YANG Yongjian, invented a camera ball head having a fast connector (see CN2004100150039). This camera pan head is provided with a fast connector, being compact in construction with high security, which can have multi-angle photo taking continuously. However, this kink of camera pan head has shortcomings as the low clamp force, large volume, and low handle movement. The reliability and stability need further improvement.

### PURPOSE OF THE INVENTION

The purpose of this invention is to provide a kind of camera pan head having two clamps locking. This pan head has two clamps locking, and quadrate knot orientation connection and a turntable. This pan head is fast to be installed, easy operation, compact structure, free rotating, easy adjustment for multi-angle photo taking, good clamping force, small volume and good security.

### TECHNOLOGY OF THE INVENTION

The purpose of this invention is achieved through the following methods:

A camera pan head having a connector with two-clamps locking, a quadrate knot orientation connection and a turntable, the camera pan head includes a sphere, a pan head base and a handle, the sphere faces upward, and the pan head base is mounted on the sphere. The sphere is set in the pan head base with the handle. There is provided with a connecting nut installed with the tripod in the bottom of the camera pan, and a fast connector on the top of the camera pan head, on the upper end of the connector is provided with the components connected with the camera, within the box body of the connector is provided with fuction components, wherein the function components of the said fast connector comprises a two clamps linkage locking mechanism consisted of a left clamp, a right clamp, a pendulum lever, a hinge and a twist spring; on one side of the camera pan head is provided with a extension handle in layers, the handle under the pan head base in the bottom of the camera pan head base is provided with a turntable mechanism; the fast connector is provided with a connecting knob component for installing the camera with the pan head.

The said function components of the fast connector comprises:

a left and a right clamp, a pendulum lever, a hinge, a twist spring, a press spring and a teeterboard. The hole in the middle of the left and right clamp is fixed with the pan head base with a pin and can be turned around the axis pin. The front end of the clamps is pressed by the twist spring, the back end of clamps is pressed by the manual clamping force when operation. The upper of the right clamp connects with the hinge hole with a axis pin. The hole in the middle of the pendulum lever is fixed with the pan head base with a pin, and can be turned around the axis pin. The hole in the front end of the pendulum lever connects the hinge hole with a axis pin. There is a concave in the lower end of the pendulum lever opposites the clamp. The concave is tooth-connecting with the protruding of the left clamp when locking, so as to provide an anti-loosing action. The concave and the protruding will separate when loosening. There is a hole in one end of the teeterboard connects the cover with a pin. The press spring is installed within the concave in the middle of the teeterboard, while the upper face of the teeterboard keeps touching the pin axis. When the left and the right clamps open, the teeterboard turns up and supports the left clamp in the effect of the press spring. Because of the linkage action, the right clamp will stay in the open position, when the pin axis is supported to the highest position by the teeterboard.

The said turntable is provided with a restriction mechanism, which can fastly lock or loose the turntable by the controlling of a knot.

The knob on the top of the said connecting connects the quadrate plate to form the connecting component, includes the knob connecting the camera by screw thread and the gluey plate adhereing with the quadrate plate. The pin inserts into the groove of the knot through a quadrate block. When the camera is locked with the pan head, the cone face of the knob touches tightly with the cone faces of the left and the right clamps.

This invention has the following merits:

This invention has compact construction, high clamp force, free rotating, multi-angle photo taking, small volume, easy taking, multi-purposed and fast attach with different kinds of camera and tripods. Its high clamping force of the two clamps can allow the camera with long lens stay at 45°. The handle is a extension handle in layers with high turning movement.

### DESCRIPTION OF THE DRAWINGS

FIG. 1 is a side view of the section showing the construction of the present invention;

FIG. 2 is a principle view of the two-clamps-joining-pole mechanism;

FIG. 3 is the construction view of the handle component;

FIG. 4 is the cross section view of A-A of FIG. 3;

FIG. 5 is the explosion view of the two-clamps-joining-pole mechanism.

### EMBODIMENTS

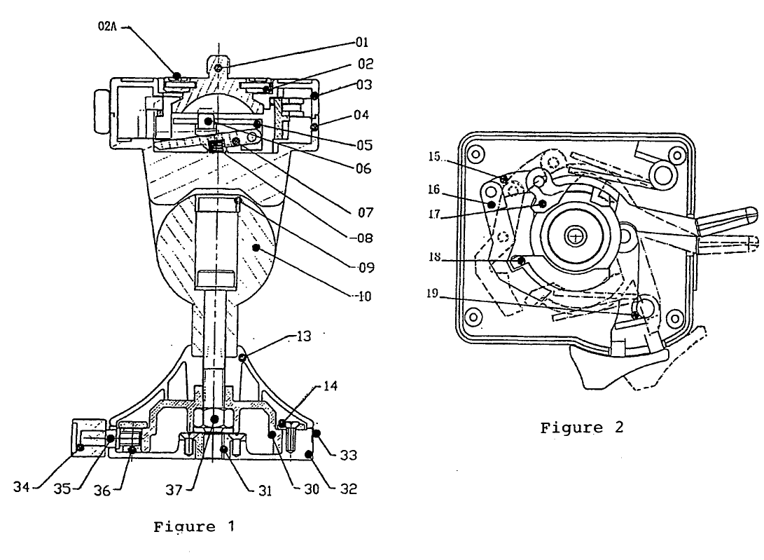

As shown in FIGS. 1-5, this innovation is a kind of camera pan head having a connector with two clamps locking, a quadrate knot orientation connection, a turntable and a extension handle in layers, consists of 3 main parts: the connector, the pan head, and the turntable set below the pan head. At the bottom of the turntable is provided with a connecting nut fixed with the tripod. On the top of the connector are provided with the quadrate plate 02 and the knot 01 connect with the camera when using. The knot is connected with the camera by the screw due to the screw connection relationship and the position of concave on the top of the connector with the quadrate plate 02, so that the camera, the pan head and the tripod can be assembled together securely.

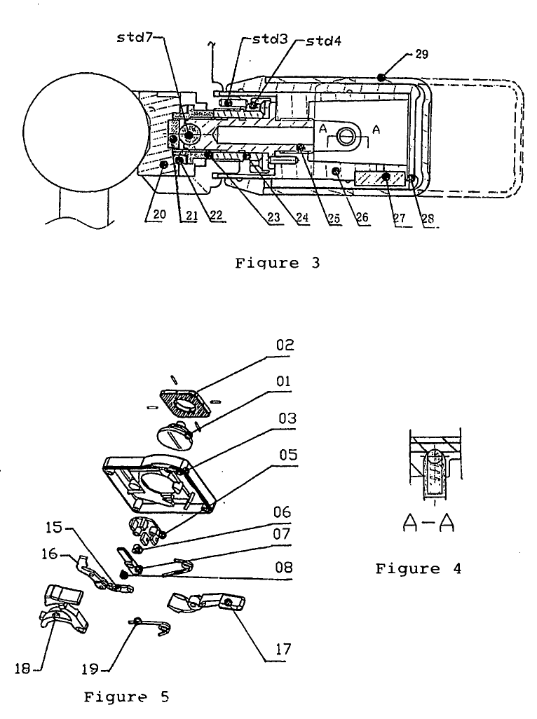

This camera pan head includes sphere 10, pan head base 04 and handle 26. The sphere faces upward, and set onto the pan head base 04 with the handle 26, the pan head base being mounted to the sphere. The connector is consisted of the function components installed between the box cover 03 and the pan head base 04. The components of the said pan head connector is as shown as in FIG. 2, the holes in the middle of the left clamp 18 and the right clamp 17 are movably connected by a pin, while the pin is fixed on the pan head base 04. The holes on both ends of the hinge 15 are movably connected with the left clamp 18 and the right clamp 17, fixed onto the pan head base 04 by the bolts. The groove in the lower part of the pendulum lever 16 is locked with the top of the left clamp. The reposition twist spring 19 will always press the left and the right clamps. As per FIG. 3, the teeterboard 07 connects with the cover 05 with a pin, while the top of which pushes a pin axis 06, the middle of the lower part of which presses the spring 08 and the end of which contacts with the clamp 18. When the camera pushes upon the working face of the pan head, the knot locked in the camera will press the pin axis 06, then the pin axis will drive the teeterboard 07 downward. The top end of the teeterboard 07 will detach from the left clamp 18. Under the twist spring 19 pressing, the left and right clamp will be driven and pressed onto the cone face of the knot, so that the groove of the pendulum lever is locked with the left clamp 18 by tooth connecting due to the linkage effect of the pendulum lever 16 and hinge 15 and carry out the linkage locking mechanism of the connector.

As shown in FIG. 3, the extension handle in layers is consisted of handle 26, sliding handle 28, and the gluey cover 29 for the handle. The sliding handle 28 is mounted on the handle 26 and covered with the gluey cover 29. The handle 26 is provided with a fix key, while the sliding handle 28 is provided with a slot. The key of the handle 26 and the slot of the sliding handle 28 are matched by the key 27, so that the twist movement can be passed. Under the driving of the screw 25, micro-adjusting nut 24, nut 23, spring 22 and rubbing resistant block 21, the pressing from the handle 26 and the sliding handle 28 passes to the left position block 20. The handle 26 drive the screw 25 to push the steel ball on its end, then further push the left position block 20, so that the sphere 10 fix tightly on the pan head base 04. On the right side of the sphere 10 is provided with a right position block and a position nut in reverse to the left ones. The micro-adjusting nut 24 set in the handle 26 can adjust the damp when sphere 10 rotating. When the twist movement of the handle is needed to be enhanced, the sliding handle 28 can be pulled from the handle 26 with the guiding of the leading key 27. So that the overall length of the handle is extended, which can also enlarge the rotating movement. Then the end-user can rotate the handle easier with larger turning moment arm.

Below the pan head sphere is provided with a turntable 30. The turntable 13 is fixed between the sphere 10 and the orientation turntable 30 with bolt and nut 37. The scale 33 is adhered into the groove of the turntable base 32. The orientation turntable 30 is positioned inside the inner hole of turntable base 32 by orientation ring 14. Knot 34 is installed in one side of the base 32 with the screw 35 and locking plate 36. The loosening and the tightening by the knot 34 can control the rotating angle of turntable 30. On top of the run-through round hole of sphere 10 there is a cap 09 for atheistic and dust-free protection.

This invention works as below:
1. The knot adheres tightly to the bottom of the camera with the quadrate plate 02 and the gluey plate 02A. The quadrate plate 02 is quadrate or polygonal. The gluey plate can protect the camera bottom and increase the friction. When the knot 01 presses the pin axis 06 downwardly, the quadrate plate is positioned with the cover 03. The pin axis 06 pushes the teeterboard 07 down, then the teeterboard 07 will be driven and separate from the left clamp 18. The left clamp 18 and the right clamp 17 will be driven and push to the cone face of the knot 01 by the twist spring 19, so that the camera will be tightly clamped onto the pan head.
2. The sliding handle 28 has a slot fit with the fix key of the handle 26. With guiding of the leading key 27, the rotating of the sliding handle 28 will drive the screw 25 to move forward. Push the steel ball (std 7) to press against the rubbing resistant block 21, then the sphere 10 will be tightly pressed by the pushing block 20.
3. The micro-adjusting nut 24 presses to the nut 23, and the nut 23 presses tightly to the plate-shape spring 22. With removing of the handle components 26,27,28,29 and rotating the micro-adjusting nut 24, the force for the camera weight can be preset. When the micro-adjusting nut rotate rightabout, the screw (std 4) will contact with the pin (std 3), the micro-adjusting nut staying stilly to avoid the loosening of the perforce.
4. To increase the locking force, the handle length can be extended by pull out the handle components 26, 27, 28, 29. This mechanism is fast and easy for operation.
5. To lock the turntable 30 in a direct and fast pace, it is needed to press down the knot 34, then the screw will be driven and pressed the lock block 36, which will be driven and pushed the orientation ring 14. When 360° panning rotation is required, it is only needed to release the knot 34.

1. A camera pan head having two clamps locked connector comprises a sphere, a pan head base and a handle, the sphere face upward, and the pan head base is mounted on the sphere, the sphere is set in the pan head base through the handle, there is provided with a connecting nut installed in the tripod in the bottom of the camera pan, and a fast connector on the top of the camera pan, on the upper end of the connector is provided with the components connected with the camera, wherein the function components of the said fast connector comprises a two clamps linkage locking mechanism consisted of a left clamp (18), a right clamp (17), a pendulum lever (16), a hinge (15) and a twist spring (19); on one side of the camera pan head base is provided with a extension handle in layers, in the handle of the sphere (10) in the bottom of the camera pan head base is provided with a turntable mechanism; fast connector is provided with a connecting knob component for installing the camera with the pan head.

2. A camera pan head having two clamps locked connector according to claim 1, wherein the function components of the connector consisted of a right clamp (17), a left clamp (18), a pendulum lever (16), a hinge (15), a twist spring (19), a press spring (08) and a teeterboard (07); the right clamp (17) and the left clamp (18) are movably connected with a pin through the hole in the middle of the axis pin and fixed on the pan head base (01), becoming the pivot in the leverage, one ends of the left and the right clamps are pressed by the twist spring (19), the other ends are pressed by the manual clamping force in the operation; the left and the right clamps are connected with the hole in the hinge (15) with a pin axis, the hole in one end of the pendulum lever (16) is connected with the hinge with a axis pin, the concave of the pendulum lever (16) is opposite the protruding of the left clamp (18) and tooth connecting when locking; one end of the teeterboard (07) is provided with a hole connected with the cover (05) with a pin, the press spring (08) is installed within the concave of the middle of the teeterboard (07), the upper face of the teeterboard (07) keeps touching the lock axis (06).

3. A camera pan head having two clamps locked connector according to claim 1, wherein the extension handle in layers comprises a handle (26), a sliding handle (28), a gluey cover (29) and a leading key (27), the handle (26) is covered by the sliding handle (28) which is covered under the gluey cover (29); within the handle (26) and the sliding handle (28) are respectively provided with a setting key and a slot, the handle (26) and the sliding handle (28) pass the twist movement with the matching of the key (25) and the slot.

4. A camera pan head having two clamps locked connector according to claim 1, wherein the turntable mechanism comprises of a sphere seat turntable (13), a turntable base (32), a scale (33), an orientation turntable (30) and a locking plate (36), outside the orientation turntable (30) is provided with a turntable orientation ring (14) and set in the turntable base (32), the sphere seat turntable (13) is fixed in the sphere (10) with a bolt.

5. A camera pan head having two clamps locked connector according to claim 4, wherein the turntable base (32) is provided with a orientation knob (34), which is locked or unlocked with the locking plate (35) with a screw (35).

6. A camera pan head having two clamps locked connector according to claim 1, wherein the knob (01) is connected with a quadrate plate (02), under the bottom face of the knob (01) is provided with a groove for screwing down with the camera, on the face of the quadrate plate is provided with a plate.

7. A camera pan head having two clamps locked connector according to claim 6, wherein the plate (02) set on the knob (01) is quadrate or polygonal.
